(19) United States
(12) Patent Application Publication
(10) Pub. No.: US 2017/0306431 A1
(43) Pub. Date: Oct. 26, 2017

(54) APPARATUS FOR HEATING A METAL BILLET

(71) Applicant: EFFMAG LTD., Espoo (FI)

(72) Inventor: Pekka SUOMINEN, Pori (FI)

(73) Assignee: EFFMAG LTD., Espoo (FI)

(21) Appl. No.: 15/516,212

(22) PCT Filed: Oct. 1, 2015
(86) PCT No.: PCT/FI2015/050653

§ 371 Date: Mar. 31, 2017

(30) Foreign Application Priority Data
Oct. 2, 2014 (FI) 20145857
Dec. 8, 2014 (CN) 201410741022.3

(51) Int. Cl. C21D 9/00; F27D 11/06; F27B 9/06; H05B 3/12; C21D 1/34

(52) U.S. Cl. CPC C21D 9/0081; H05B 3/12; C21D 1/34; F27B 9/067; F27D 11/06

(57) ABSTRACT

An apparatus for heating a metal billet such as a billet of non-ferrous metal, includes a frame, a heating container having a longitudinal billet receiving inner space, and at least one heater element configured to heat the heating container. The heating container is divided along parting surfaces into parts. The parts are movable arranged with respect to each other. Each part has a contact surface facing the longitudinal billet receiving inner space. Each part has at least one heater element configured to heat the part.

### FIELD OF THE INVENTION

The invention relates to an apparatus for heating a metal billet as defined in the preamble of independent claim 1.

An use of the apparatus may be to pre-heat a metal billet such as non-ferrous metal billet comprising for example aluminum, copper, or zinc prior charging the metal billet into an extrusion machine.

Various methods and apparatuses for heating metal billets are known in the art.

A common technique that is used is to use electromagnetic induction in the beating process. A such method device and arrangement is described in publication WO 2010/100082.

### OBJECTIVE OF THE INVENTION

The object of the invention is to provide an energy efficient apparatus for heating metal billets.

### SHORT DESCRIPTION OF THE INVENTION

The apparatus for heating a metal billet of the invention is characterized by the definitions of independent claim 1.

Preferred embodiments of the apparatus for heating a metal billet are defined in the dependent claims.

The invention is based on dividing, the heating container of the apparatus along parting surfaces into parts, which are movable arranged with respect to each other. Each part of the heating, container has a contact surface facing a longitudinal billet receiving inner space for receiving a metal billet to be heated. Each part of the heading container has at least one heater element configured to heat the part of the heating container.

The function principle of the apparatus is to heat a metal billet by transferring thermal energy from the heating container to a metal billet in the longitudinal billet receiving inner space of the heating container. The apparatus utilizes mainly conductive heat transfer, which departs from existing billet heaters such as gas ovens, inductive ovens, resistive heaters,

In a preferred embodiment of the apparatus, the apparatus comprises pressing means for forcing at least one part of the heating container towards the longitudinal billet receiving inner space. This provides for improved thermal contact between the part and the metal billet to be heated. Because the function principle of the apparatus is to heat a metal billet by conducting thermal energy from the heating container to a metal billet in the longitudinal billet receiving inner space of the heating container, heating of a metal billet by means of said at least one part of the heating container will in practice stop when said at least one part of the heating container is moved from contact with a metal billet that is received in the longitudinal billet receiving inner space of the heating container. This can be used for heating different parts of a metal billet to different temperatures for example so that one end of the metal billet has a higher temperature than the other end of the metal billet, provided that the heating container is in its longitudinal direction divided into parts.

If the apparatus comprises pressing means, the pressing means may be configured to move said at least one part of the heating container away from longitudinal billet receiving inner space when a metal billet is removed from the longitudinal billet receiving inner space for allowing removal of the metal billet from the longitudinal billet receiving inner space and for allowing placing of a metal billet into the longitudinal billet receiving inner space. Correspondingly, the pressing means may be configured to move said at least one part of the heating container towards longitudinal billet receiving inner space when a metal billet is placed into the longitudinal billet receiving inner space.

If the apparatus comprises pressing means, the apparatus may be configured to automatically turn off the heating element of said at least one part when the pressing means move said at least one part of the heating container away from longitudinal billet receiving inner space of the heating container. Correspondingly, the apparatus may be configured to automatically turn on the heating element of said at least one part when the pressing means move said at least one part of the heating container towards longitudinal billet receiving inner space of the heating container, in a preferred embodiment of the apparatus, the apparatus comprises suspension means for elastically allowing at least one part of the heating container to move in a direction away from longitudinal billet receiving inner space as a result of heat expansion of a metal billet receive in the longitudinal billet receiving inner space. This provides for good thermal contact between the pan and the metal billet to be heated without the risk of breaking the apparatus.

### LIST OF FIGURES

in the following the invention will described in more detail by referring to the figures, of Which

FIG. 1 shows apparatus according to a first embodiment,

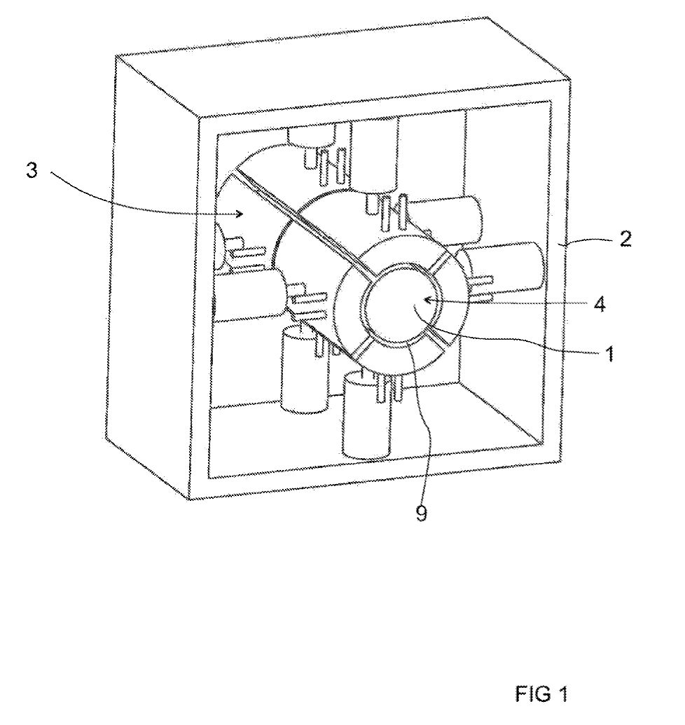

FIG. 2 shows parts of the apparatus shown in FIG. 1, and

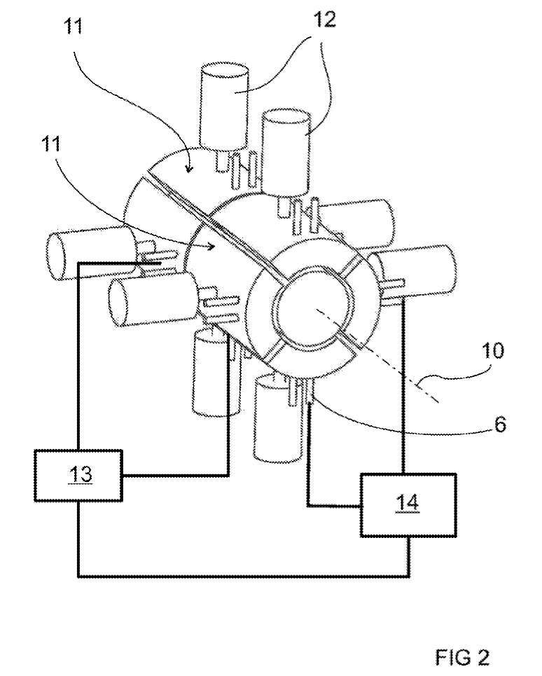

FIG. 3 shows an alternatively configuration to some of the parts shown in FIG. 2.

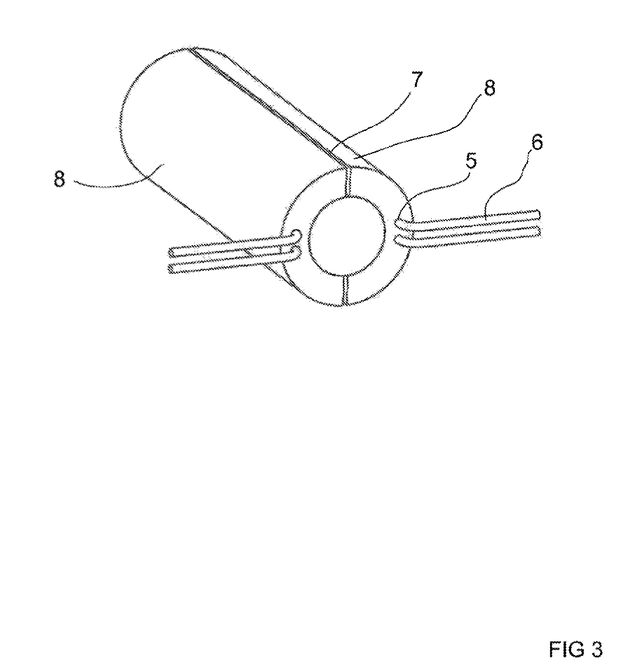

### DETAILED DESCRIPTION OF THE INVENTION

The invention relates to an apparatus for heating a metal billet 1 such as a billet of non-ferrous for example a billet comprising aluminum, copper, or zinc.

The apparatus comprises a frame means 2.

The apparatus comprises a heating container 3 having a longitudinal billet receiving inner space 4.

The apparatus comprises a heater element 6 such as an electrical heater element configured to heat the heating container 3.

In the apparatus, the heating container 3 is divided along parting surfaces 7 into parts 8, which are movable arranged with respect to each other.

Each part 8 of the heating container 3 has a contact surface 9 facing the longitudinal billet receiving inner space 4.

Each part 8 of the heating container 3 have at least one heater element 6 configured to heat the part 8 of the heating container.

Each part 8 of the heating container 3 may have at least one hole 5, such as a bore, and a heater element 6 in at least one hole 5 of the part. This ensures good thermal contact between the part 8 of the heating container and the heater element in such case, the heater element 6 may be form-fitted into the hole 5. Alternatively, the at least one part 8 of the heating container 3 may be provided with a heater element 6 that is attached to the surface of said at least one part 8 of the heating container 3 in thermal contact with said at least one part 8 of the heating container 3.

The longitudinal billet receiving inner space 4 has preferably two open opposite ends (not marked with a reference numeral).

In the embodiments shown in the figures, the longitudinal billet receiving inner space 4 is in the form of a longitudinal cylindrical billet receiving inner space, and the longitudinal cylindrical billet receiving inner space has a circular cross-section shape and a center line 10.

If the longitudinal billet receiving inner space 4 is in the form of a longitudinal cylindrical billet receiving inner space, having a circular cross-section shape and a center line 10, the heating container 3 may be divided into parts 8 along parting surfaces 7 in the form of parting planes at least partly parallel with the center line 10 of the longitudinal cylindrical billet receiving inner space. In such case the heating container 3 may be divided along parting surfaces 7 into identical parts 8 such as into 2, 3, 4, 5, 6, 7, 8, 9, or 10 identical parts 8 or into 2 to 100 identical parts 8.

If the longitudinal billet receiving inner space 4 is in the form of a longitudinal cylindrical billet receiving inner space, having a circular cross-section shape and a center line 10, the heating container 3 may be divided into parts 8 along parting surfaces 7 in the form of parting planes at least partly parallel with the center line 10 of the longitudinal cylindrical billet receiving inner space. In such case the batting container 3 may be divided along parting surfaces 7 into parts 8 such as into 2, 3, 4, 5, 6, 7, 8, 9, or 10 parts 8 or into 2 to 100 parts 8.

If the longitudinal billet receiving inner space 4 is in the form of a longitudinal cylindrical billet receiving inner space, having a circular cross-section shape and a center line 10, each of the parts 8 may have a contact surface 9 having a curved cross section so that by none of the parts 8 forming at any location along the longitudinal cylindrical billet receiving inner space of the heating container 3 more than half of the circular cross-section shape of the longitudinal cylindrical billet receiving inner space.

If the longitudinal billet receiving inner space 4 is in the form of a longitudinal cylindrical billet receiving inner space, having a circular cross-section shape and a center line 10, the heating container 3 may be divided into heating container sections 11 along parting surfaces 7 in the form of parting planes at least partly perpendicular with the center line 10 of the longitudinal cylindrical billet receiving inner space, so that each heating container section 11 is additionally divided into parts 8 along parting surfaces 7 in the form of parting planes at least partly parallel with the center line 10 of the longitudinal cylindrical billet receiving inner space. In such case, the beating container 3 may be divided in the longitudinal direction of the heating container 3 into 2, 3, 4, 5, 6, 7, 8, 9, or 10 identical heating container sections 11 or into 2 to 100 heating container sections 11 and each beating container section 11 may being divided into identical parts 8 such as into 2, 3, 4, 5, 6, 7, 8, 9, or 10 identical parts 8 or into 2 to 100 identical parts.

If the longitudinal billet receiving inner space 4 is in the form of a longitudinal cylindrical billet receiving inner space, having a circular cross-section shape and a center line 10, the heating container 3 may be divided into heating container sections 11 along parting surfaces 7 in the form of parting planes at least partly perpendicular with the center line 10 of the longitudinal cylindrical billet receiving inner space, so that each heating container section 11 is additionally divided into parts 8 along parting surfaces 7 in the form of parting planes at least partly parallel with the center line 10 of the longitudinal cylindrical billet receiving inner space. In such case, the heating container 3 may be divided in the longitudinal direction of the heating container 3 into 2, 3, 4, 5, 6, 7, 8, 9, or 10 heating container sections 11 or into 2 to 100 heating container sections 11, and each heating container section 11 may being divided into parts 8 such as into 2, 3, 4, 5, 6, 7, 8, 9, or 10 parts 8 or into 2 to 100 parts.

If the heating container 3 is divided into such heating container sections 11, the apparatus may comprise temperature sensor means 13 for separately measuring the temperature in each heating container section 11 individually and temperature control means 14 for individually adjusting the temperature in each heating container section 11 individually by adjusting at least one heater element 6 in the heating container section 11, preferably, but not necessarily, based on the temperature in the heating container section 11 measured by the temperature sensor means 13. If the heating container 3 is divided into such heating container sections 11, the apparatus may comprise a temperature sensor means 13 for measuring the temperature in one or more heating container section 11 and temperature control means 14 for adjusting the temperature in said one or more heating container sections 11 by adjusting at least one heater element 6 in each heating container section 11 of said several heating container sections 11, preferably, but not necessarily, based on the temperature in said several heating container sections 11 measured by the temperature sensor means 13. If the heating container 3 is divided into such heating container sections 11, the apparatus may comprise a temperature sensor means 13 for measuring the temperature in one heating container section 11 of a group of several heating container sections 11, and the apparatus may comprise temperature control means 14 for adjusting the temperature in said group of several heating container sections 11 by adjusting at least one heater element 6 in each heating container section 11 of said group of several heating container sections 11.

In contrast to the embodiments shown in the figures, each of the parts 8 of the heating container 3 may have a contact surface 9 that is planar. In such case the heating container 3 may be divided along parting surfaces 7 in the form of parting planes into identical parts 8 such as into 2, 3, 4, 5, 6, 7, 8, 9, or 10 identical parts 8 or into 2 to 100 identical parts 8. In such case the heating container 3 may be divided along parting surfaces 7 in the form of parting planes into heating container sections 11 such as into 2, 3, 4, 5, 6, 7, 8, 9, or 10 identical heating container sections 11 or into 2 to 100 heating container sections 11. In such case the heating container 3 may be divided along parting surfaces 7 in the form of parting planes into heating container sections 11 such as into 2, 3, 4, 5, 6, 7, 8, 9, or 10 identical heating container sections 11 or into 2 to 100 heating container sections 11 and each heating container sections 11 may be divided along parting surfaces 7 in the form of parting planes into identical parts 8 such as into 2, 3, 4, 5, 6, 7, 8, 9, or 10 identical parts 8 or into 2 to 100 identical parts 8.

The apparatus comprises preferably, but not necessarily, pressing means 12 for forcing at least one part 8 of the heating container towards the longitudinal billet receiving inner space 4. The apparatus comprises more preferably, but not necessarily, several pressing means 12 each arranged for forcing one part 8 of the heating container towards the longitudinal billet receiving inner space 4. Such pressing means 12 is attached to the frame means 2 and to the part 8 of the heating container 3, if the apparatus comprises pressing means 12, the pressing means 12 may be configured to additionally act as a suspension means configured to allow said at least one part 8 to move in a direction away from the longitudinal billet receiving inner space 4 as a result of heat expansion of a metal billet 1 in the longitudinal billet receiving, inner space 4. Especially pressing means comprising pneumatic or hydraulic cylinders (not shown in the figures) may be arranged to function in this manner. If the apparatus comprises pressing means 12 the pressing means 12 may be attached to at least one of said frame means 2 and said at least one part 8 by means of a suspension means configured to allow said at least one part 8 to move in a direction away from the longitudinal billet receiving inner space 4 as a result of heat expansion of a metal billet 1 in the longitudinal billet receiving inner space 4.

If the longitudinal billet receiving inner space 4 is in the form of a longitudinal cylindrical billet receiving inner space, having a circular cross-section shape and a center line 10, the apparatus comprises preferably, but not necessarily pressing means 12 for forcing at least one part 8 towards the center line 10 of the longitudinal cylindrical billet receiving inner space. In such case, the apparatus comprises more preferably, but not necessarily, several pressing means 12 each arranged for forcing one part 8 of the heating container towards the center line 10 of the longitudinal cylindrical billet receiving inner space 4. Such pressing means 12 is attached to the frame means 2 and to the part 8 of the heating container. If the apparatus composes pressing means 12, the pressing means 12 may be configured to additionally act as a suspension means configured to allow said at least one part 8 to move in a direction away from the longitudinal billet receiving inner space 4 as a result of heat expansion of a metal billet 1 in the longitudinal billet receiving inner space 4. Especially pressing means comprising pneumatic or hydraulic cylinders (not shown in the figures) may be arranged to function in this manner. If the apparatus comprises pressing means 12, the pressing means 12 may be attached to at least one of said frame means 2 and said at least one part 8 by means of a suspension means configured to allow said at least one part 8 to move in a direction away from the longitudinal billet receiving inner space 4 as a result of heat expansion of a metal billet 1 in the longitudinal billet receiving inner space 4.

If the apparatus comprises pressing means 12, the pressing means 12 comprises preferably, hut not necessarily, at least one of the following pneumatic or hydraulic cylinders, or linear actuators.

The apparatus may comprise suspension means for allowing at least one part 8 to move in a direction away from the longitudinal billet receiving inner space 4 as a result of heat expansion of a metal billet 1 in the longitudinal billet receiving inner space 4. The apparatus may more preferably compose several suspension means each for allowing, one part 5 to move in a direction away from the center line 10 of the longitudinal billet receiving inner space 4 as a result of heat expansion of a metal billet 1 in the longitudinal billet receiving inner space 4. If the apparatus comprises pressing means 12 for forcing at least one part 8 towards the longitudinal billet receiving inner space 4, the pressing means may be arranged to also function as suspension means.

If the longitudinal billet receiving inner space 4 is in the form of a longitudinal cylindrical billet receiving inner space, having a circular cross-section shape and a center line 10, the apparatus may comprise suspension means for allowing at least one part 8 to move in a direction away from the center line 10 of the longitudinal cylindrical billet receiving inner space as a result of heat expansion of a metal billet 1 in the longitudinal cylindrical billet receiving inner space. In such case, the apparatus comprises more preferably several suspension means each for allowing one part 8 to move in a direction away from the center line 10 of the longitudinal cylindrical billet receiving inner space as a result of heat expansion of a metal billet 1 in the longitudinal cylindrical billet receiving inner space. If the apparatus comprises pressing means 12 for forcing at least one part 8 towards the longitudinal cylindrical billet receiving inner space 4, the pressing means may he arranged to also function as suspension means.

The apparatus comprises preferably, but not necessarily, a temperature control means 14 for controlling at least two heater elements 6 of different parts 8 of the heating container 3.

The parts 8 are preferably, but not necessarily, made at least partly of metal such as of copper or steel. The parts 8 can be coated and/or the surface of the parts 8 can be treated in order to improve the thermal contact between the metal billet 1 and the parts 8 and/or to decrease sticking between the metal billet 1 and parts 8. The apparatus comprises preferably, but not necessarily, temperature sensor means 13 for measuring the temperature of at least one part 8 of the heating container

The apparatus comprises preferably, but not necessarily, temperature sensor means 13 for individually measuring the temperature of several parts 8 of the heating container 3.

The apparatus comprises preferably, but not necessarily, insulation means (not shown in the drawings) for at least partly thermally insulating the heating container 3.

It is apparent to a person skilled in the art that as technology advanced, the basic idea of the invention can be implemented in various ways. The invention and its embodiments are therefore not restricted to the above examples, but they may vary within the scope of the claims.

1. An apparatus for pre-heating a metal billet including billets of non-ferrous metal prior to charging the metal billet into an extrusion machine, said apparatus comprising:
a frame;
a heating container having a longitudinal billet receiving inner space; and
at least one heater element configured to heat the heating container, the longitudinal billet receiving inner space being in the form of a longitudinal cylindrical billet receiving inner space, having a circular cross-section shape and a center line;
the heating container being divided into parts along parting surfaces in the form of parting planes at least partly parallel with the center line of the longitudinal cylindrical billet receiving inner space, the heating container being divided along parting surfaces into 3-100 parts, the parts being configured and arranged with respect to each other, each part having a contact surface facing the longitudinal billet receiving inner space, and each part having at least one heater element configured to heat the part;and
suspension means for allowing at least one part to move in a direction away from the longitudinal billet receiving inner space as a result of heat expansion of a metal billet in the longitudinal billet receiving inner space.

2. The apparatus according to claim 1, wherein each part comprises:
at least one hole and a heater element in the at least one hole of the part

3. The apparatus according to claim 1, comprising:
pressing means for forcing at least one part towards the longitudinal billet receiving inner space, the pressing means being attached to said frame means and attached to said at least one part for moving said at least one part with respect to said frame.

4. The apparatus according to claim 3, wherein the pressing means configured to act at least as a part of the suspension means configured to allow said at least one part to move in a direction away from the longitudinal billet receiving inner space as a result of heat expansion of a metal billet in the longitudinal billet receiving inner space.

5. The apparatus according to claim 3, wherein the pressing means is attached to at least one of said frame and said at least one part by the suspension means configured to allow said at least one part to move in a direction away from the longitudinal billet receiving inner space as a result of heat expansion of a metal billet in the longitudinal billet receiving inner space.

6. The apparatus according to claim 1, wherein each of the parts has a contact surface having a curved cross section, and none of the parts is formed at any location along the longitudinal cylindrical billet receiving inner space of the heating container which is more than half of the circular cross section shape of the longitudinal cylindrical billet receiving inner space.

7. The apparatus according to claim 1, wherein the heating container is divided into heating container sections along parting surfaces formed as parting planes at least partly perpendicular with the center line of the longitudinal billet receiving inner space, and by each heating container section is divided into parts along parting surfaces formed as parting planes at least partly parallel with the center line of the longitudinal cylindrical billet receiving inner space.

8. The apparatus according to claim 7, wherein the heating container is divided in the longitudinal direction of the heating container into any of at least 3-100 identical heating container sections, and by each heating container section divided into identical parts represented by any of at least 3-100 identical parts.

9. The apparatus according to claim 7, wherein the heating container is divided in the longitudinal direction of the heating container(3) into any of at least 3-100 heating container section, and heating container section is divided into parts such as into any of at least 3-100 parts.

10. The apparatus according to claim 7, comprising:
temperature sensor means for separately measuring temperature in each heating container section individually; and
temperature control means for individually adjusting the temperature in each heating container section individually by adjusting at least one heater element in the heating container section.

11. The apparatus according to claim 7, comprising:
temperature sensor means for measuring temperature in one heating container section of a group of several heating container sections; and
temperature control means for adjusting the temperature in said group of several heating container sections by adjusting at least one heater element in each heating container section of said group of several heating container sections.

12. The apparatus according to claim 1, comprising:
controlling means for controlling at least two heater elements of different parts of the heating container.

13. The apparatus according to claim 1, wherein the parts of the heating container are made at least partly of metal.

14. The apparatus according to claim 1, comprising:
sensor means for measuring the temperature of at least one part of the heating container.

15. The apparatus according to claim 1, comprising:
insulation means for at least partly thermally insulating the heating container.

16. The apparatus according to claim 1, wherein the parts of the heating container are made at least partly of metal selected from a group consisting of copper and steel.

17. The apparatus according to claim 2, comprising:
pressing means for forcing at least one part towards the longitudinal billet receiving inner space, the pressing means being attached to said frame and attached to said at least one part for moving said at least one part with respect to said frame.

18. The apparatus according to claim 4, wherein the pressing means is attached to at least one of said frame and said at least one part by the suspension means configured to allow said at least one part to move in a direction away from the longitudinal billet receiving inner space as a result of heat expansion of a metal billet in the longitudinal billet receiving inner space.

19. The apparatus according to claim 9, comprising:
temperature sensor means for separately measuring temperature in each heating container section individually; and
temperature control means for individually adjusting the temperature in each heating container section individually by adjusting at least one heater element in the heating container section.

20. The apparatus according to claim 9, comprising:
temperature sensor means for measuring temperature in one heating container section of a group of several heating container sections; and
temperature control means for adjusting the temperature in said group of several heating container sections by adjusting at least one heater element in each heating container section of said group of several heating container sections.
